(19) United States
(12) Patent Application Publication
(10) Pub. No.: US 2004/0248534 A1
(43) Pub. Date: Dec. 9, 2004

(54) Radio receiver having program memories and control elements assigned or able to be assigned to the program memories

(76) Inventor: Christian Meyer, Hannover (DE)

Correspondence Address: KENYON & KENYON, ONE BROADWAY, NEW YORK, NY, 10004, US

(21) Appl. No.: 10/778,473

(22) Filed: Feb. 12, 2004

(30) Foreign Application Priority Data
Feb. 12, 2003 (DE) 103 05 659.9

(51) Int. Cl. H04B 1/18

(52) U.S. Cl. 455/177.1; 455/150.1

(57) ABSTRACT

A radio receiver having selection elements for selecting a radio program to be received and program memories storing information required for setting a radio program to be received is provided. The program memories are assigned to the respective selection elements, and a desired program memory may be called up by operating a desired selection element assigned to the desired program memory, independently of the broadcast method (e.g., analog VHF FM radio, analog MW, LW, SW AM radio, DAB, or DRM) of a program received prior to operation of the selection element. In this manner, the present invention enables the user's preferred radio programs to be distributed on the same station button level, e.g., on a first of several station button levels, to the station buttons available on this level, independently of the broadcast method of the preferred radio programs. As a result, the preferred radio programs may be called up independently of their broadcast method simply by operating one station button, i.e., without previously selecting a station button level or selecting a broadcast method.

### FIELD OF THE INVENTION

The present invention relates to a radio receiver including program memories and control elements assigned or able to be assigned to the program memories.

### BACKGROUND INFORMATION

Radio receivers include automotive radios and home receivers that include a plurality of station buttons, the operation of which causes the radio program stored under the station button to be set on the receiver and subsequently received. For this purpose, program memories (in which the information required to set the radio receiver to a certain radio program is stored) are assigned to the station buttons. In the case of today's common VHF FM radio receivers, this information includes a so-called PI (program identification) code in accordance with the RDS (radio data system) specification DIN/EN 50067 that clearly identifies a radio program, and at least one incoming frequency at which the radio program including the stored PI code is able to be received.

Moreover, high-grade automotive radio devices are typically also capable of receiving AM radio stations. For this case, at least the incoming frequencies at which the respective radio program is broadcast are stored in the program memories assigned to the AM radio stations.

Since in the case of radio receivers, particularly automotive radios, the space available on the front panel of the radio receiver for control elements is often very limited, while at the same time there is the demand for a large number of program memory spaces for storing a plurality of radio programs, each of the station buttons used for selecting the program storage space are typically assigned a plurality of times. In the case of such radio receivers, the memory is often organized in multiple levels, the number of program storage spaces on each storage level equaling the number of station buttons arranged on the front cover. Radio receivers that are configured for receiving VHF FM radio stations as well as AM radio stations also include separate memory levels for VHF FM and AM radio stations, the latter also being restricted in some instances to special reception bands, such as MW, LW, or SW.

The stored radio stations or programs are organized such that the programs located on the same memory level as a currently set program may be called up directly by operating the assigned station button. For all other radio programs, ones that are broadcast according to a different method or in another reception band than the currently set one, it is necessary to first operate a so-called band or memory level change button. In the case of more than one memory level (e.g., two levels for all four station buttons for VHF FM, one level for MW AM, one for SW AM, i.e., a total of four memory levels), the band change button may need to be operated several times depending on the level that is set, before the desired station is able to be set by operating a station button.

### SUMMARY

The radio receiver according to the present invention circumvents the conventional distribution of stored radio programs on different memory levels or station button (assignment) levels as a function of the broadcast method. As a result, it is now possible to store radio programs of different broadcast methods on the same station button level. This has the pleasant effect for the user in that the user's preferred radio programs may be distributed independently of their broadcast method, for example, on a first of several station button levels, and assigned to the station buttons available on this level. As a result, the preferred radio programs are able to be called up independently of their broadcast method, simply by operating one station button. It may not be necessary to operate the band change button to set a radio program that is broadcast according to a broadcast method deviating from the set radio program. As a result, provided that the radio programs preferred by the user do not exceed the number of station buttons available on the front cover of the automotive radio, changes may be made between these preferred radio programs by operating a single station button.

The present invention therefore eliminates a long-standing lack of convenience in connection with the operation of radio receivers.

### BRIEF DESCRIPTION OF THE DRAWINGS

FIG. 1 shows a block diagram of a first exemplary embodiment of a radio receiver according to the present invention.

FIG. 2 shows a block diagram of a second exemplary embodiment of a radio receiver according to the present invention.

### DETAILED DESCRIPTION

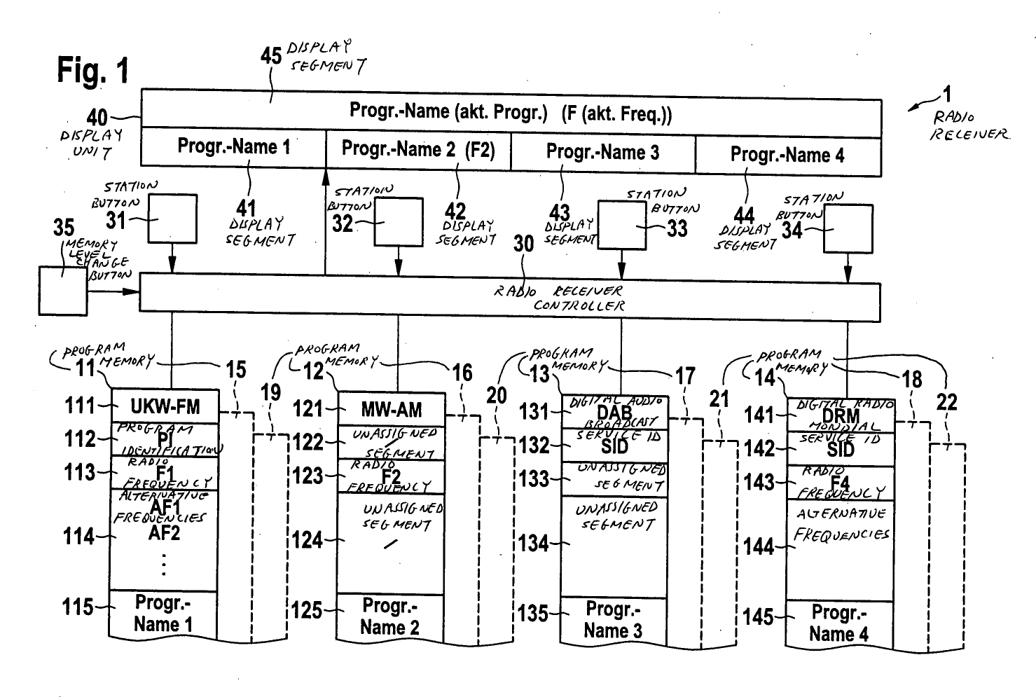

FIG. 1 shows a block diagram of a first exemplary embodiment of a radio receiver 1 according to the present invention.

The radio receiver 1 includes a plurality of, in this instance four, so-called station buttons 31, 32, 33, 34. Each of station buttons 31, 32, 33, and 34 is assigned at least one program memory 11, 12, 13, 14. In the present case, three memory levels are provided so that each station button is assigned or may be assigned three program memories 11, 15, 19 (to first station button 31), 12, 16, 20 (to second station button 32), 13, 17, 21 (to third station button 33), and 14, 18, 22 (to the fourth station button) via a memory level change button 35.

The information required for setting a radio program to be received or allowing the radio receiver to be tuned to a certain radio program is stored or may be stored in the program memories.

According to the present invention, the radio programs stored under the station buttons are no longer distributed to the different memory levels according to their reception methods. As a result, the information regarding the different radio programs that are broadcast according to different methods may be stored on every memory level. For this purpose, all program memories 11 through 22 include a similar, universal structure regardless of the memory level so that all relevant information regarding programs of any broadcast or reception method able to be received by the radio receiver may be stored therein. This will be explained below in further detail below.

In the example in FIG. 1, the data of a first radio program receivable via VHF FM (very high frequency wave band, frequency modulation) radio is stored in first program memory 11 of the first memory level, the data of a second program receivable via MW AM (middle wave band, amplitude modulation) radio is stored in second program memory 12 of the first memory level, the data of a DAB (digital audio broadcasting) radio program is stored in third program memory 13 of the first memory level, and the information of a fourth radio program via DRM (digital radio mondial) is stored in fourth program memory 14 of the first memory level. Additional information regarding further radio programs may be stored in additional program memories 15 through 22 of the additional memory levels. These are however not explicitly shown in the figure for the sake of clear representation.

To identify the method according to which the program stored there is broadcast, a reference to a VHF FM radio station is stored in a first memory segment 111 of first program memory 11. Furthermore, the PI (program identification) code of the radio program is stored in a second memory segment 112 of the first program memory. This information enables controller 30 of the radio receiver to start a station search run in the VHF band for a radio frequency via which the desired PI code and, as such, the desired radio program are able to be received.

In addition to this information for setting and receiving the stored program, additional information facilitating accelerated setting of the stored program may be stored, for example radio frequency F1 at which the program was last received in third memory segment 113 and a list of alternative radio frequencies (AF) at which the same radio program is able to be received in a fourth memory segment 114. The latter may be acquired from the radio data signal of this radio program, for example.

To identify the second radio program receivable in the middle wave band, a corresponding reference to an MW AM station is stored in first memory segment 121 of second program memory 12. Radio frequency F2 at which the second program is receivable within the MW band is stored in third memory segment 123 of the second program memory. As a result, the radio receiver is capable of tuning to the stored radio frequency and receiving the second radio program in response to operation of second station button 32.

Since PI codes or comparable information is not broadcast via analog MW AM radio and a corresponding program identifier is consequently not available, second memory segment 122 of second program memory 12 remains unassigned. The same also applies to fourth memory segment 124 since alternative frequencies are not provided for MW AM radio.

In the case of third program memory 13, an identifier for a DAB radio program is entered in its first memory segment 131. Furthermore, a so-called SID (service ID) is stored in second memory segment 132. This information may allow controller 30 of the radio receiver to check all receivable DAB radio frequencies, or in DAB jargon, ensembles, for the stored SID and to set those stations via which the stored SID and as such the desired program are broadcast.

In the case of the third (DAB) radio program, the third and fourth memory segments 133 and 134 also remain unassigned.

In the case of fourth program memory 14, an identifier for a program broadcast via DRM is stored in its first memory segment 141. Moreover, an SID (service identifier) is stored in second memory segment 142, a SID being clearly assigned to a program also in the case of DRM. Since a number of frequency bands are used in the case of DRM and consequently come into consideration so that a search run for the radio frequency at which the desired fourth program is broadcast may be very lengthy, radio frequency F4 at which the fourth program is received is additionally stored in third memory segment 143 of fourth program memory 14. As a result, the controller may set the receiving part of the radio receiver to fourth radio frequency F4 for receiving the fourth program.

Alternative frequencies that are then able to be stored in fourth memory segment 144 of fourth program memory 14 may be provided also in the case of DRM radio. However, these are not considered more closely here.

If first station button 31 is operated in the case of an activated first memory level that is reached from another memory level by operating memory level change (or band change) button 35 one or more times (if necessary), controller 30 of radio receiver 1 reads out from first program memory 11 the data relevant for tuning the receiver, i.e., in this case VHF band, PI code, and last received radio frequency F1. The controller consequently sets the VHF frequency band at the receiving part of the radio receiver (not shown in the figure) and adjusts the receiving part to last set radio frequency F1 according to the requirements of the stored radio frequency or the representative information. The PI code receivable via radio frequency F1 is compared to the stored PI code. If there is matching, radio receiver 1 is tuned to the first program for which data is stored in first program memory 11.

Analogously, the radio receiver is set to the second (MW AM) radio program stored in second program memory 12 in response to operation of second station button 32, to the third (DAB) radio program stored in third program memory 13 in response to operation of third station button 33, or to the fourth (DRM) radio program stored in fourth program memory 14 in response to operation of fourth station button 34.

To facilitate the selection of a radio program stored in one of the program memories, an exemplary embodiment of the present invention provides that program names or self-explanatory program name abbreviations (progr. name 1, progr. name 2, progr. name 3, progr. name 4), for example NDR 1 for the first program of the North German Radio Station, of the programs available in the current memory level are displayed in display segments 41, 42, 43, and 44 of a display unit 40, e.g., with spatial assignment to station buttons 31, 32, 33, and 34. These displayable program names may be each stored in a fifth segment 115, 125, 135, 145 of program memories 11, 12, 13, and 14, respectively, and are read out from the program memories by controller 30 according to the selection of the relevant memory level via memory level change button 35 and are displayed on display segments 41 through 44 of display unit 40 assigned to station buttons 31 through 34. In the case of the first program that is receivable via VHF FM radio, this designation may be acquired from the information of the radio data signal, e.g., the PS (program service name).

Alternatively, the designation may also be one that is freely assigned by the user. Analogously, also in the case of program names 3 and 4 of the third and fourth radio program, the name may relate to information broadcast and received with the program. This information is not available in the case of MW AM radio (second program) so that either a program name 2 defined and entered by the user or radio frequency F2 is shown in this instance.

In this context, the program names are shown as a function of the activated memory level and program memories 11 through 14, or 15 through 18, or 19 through 22 consequently assigned to station buttons 31 through 34.

In a fifth segment 45 of display unit 40, the program name, the program abbreviation, or if such information is not receivable and not stored, i.e., in the case of analog AM radio, the current incoming frequency is displayed.

To store a radio program as in other systems, e.g., automotive radio devices of the company Blaupunkt GmbH, a radio program is set by the user manually or via search run. Then the required information, and if applicable, additional information for setting the receiver to this program, are read into the program memory currently assigned to the station button and stored there in a manner that is lasting yet able to be overwritten.

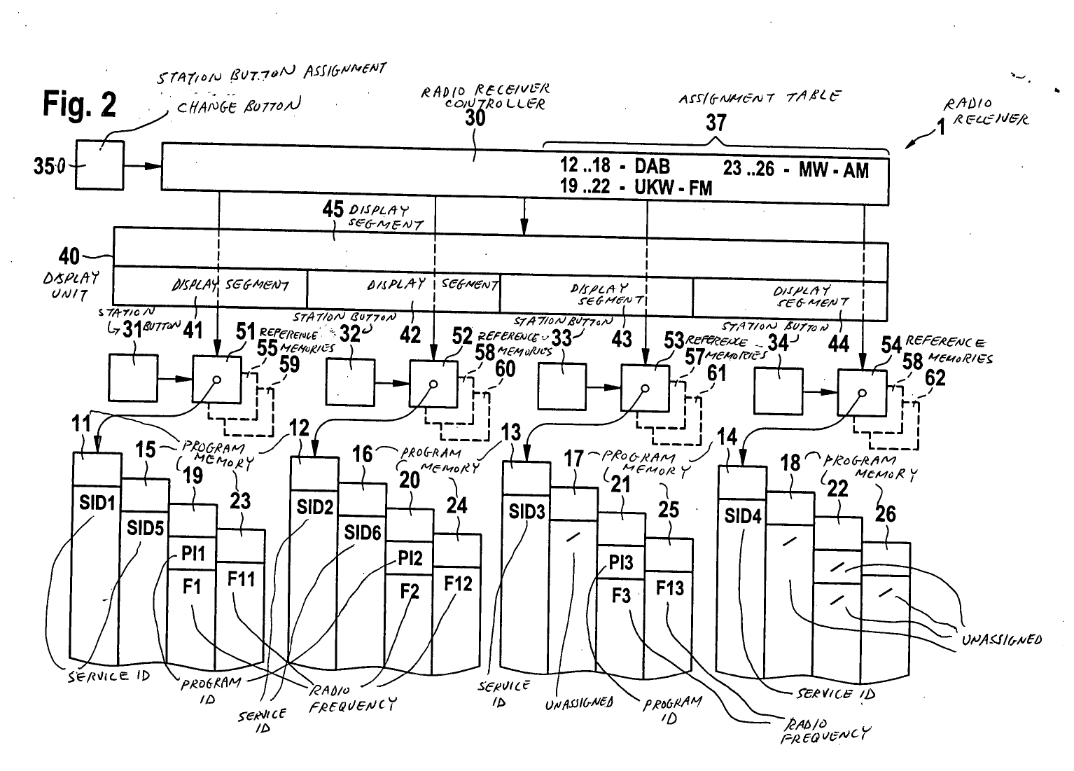

A block diagram of a second exemplary embodiment of the present invention is shown in FIG. 2.

The embodiment shown in FIG. 2 is partially based on the memory structure of radio receivers according to other systems in which one or more memory levels are each reserved for certain broadcast methods.

In the case of the radio receiver 1 shown in FIG. 2, four memory levels of program memories are provided: program memories 11 through 14 and 15 through 18 of the first two levels are reserved for DAB programs, while program memories 19 through 22 of a third level are reserved for VHF FM programs, and program memories 23 through 26 of a fourth level are reserved solely for radio programs receivable via MW AM. In comparison with the first exemplary embodiment, the embodiment of FIG. 2 does not require a universal program memory that at the same time is suitable for the information of all broadcast methods. Rather, programs memories on every memory level that are set to a certain broadcast method (and therefore save memory space) are sufficient in this instance.

Memory savings results from a fixed assignment of program memory spaces 11 through 18, 19 through 22, and 23 through 26 to a respective broadcast method such that a corresponding designation memory segment (comparable to 111, 121, 131, 141 as shown in FIG. 1) is not necessary. In this instance, the assignment of a memory level may be realized by an assignment table 37 in controller 30. In this context, it is sufficient to assign an entire memory level as opposed to individual program memories to a broadcast method.

In the case of the first eight program memories 11 through 18, which are reserved for DAB, memory space only needs to be reserved for the SID (service ID) of the stored programs, SID1, SID2, SID3, SID4, SID5, SID6 in this instance; the other program memories 17 and 18 are unassigned in the situation shown in FIG. 2. In the case of MW AM memory spaces 23 through 26, memory space only needs to be reserved for incoming frequencies F11, F12, F13; space 26 is unassigned in this instance. Only in the case of VHF FM memory spaces 19 through 22 of the third level is greater memory required for PI codes PI1, PI2, PI3, memory space 22 is unassigned, as well as for incoming frequencies F1, F2, F3, and in some instances, for additional AF (alternative frequency) lists.

Furthermore, as in the case of the first exemplary embodiment, program names may be stored in memory segments reserved for this purpose (which correspond to memory segments 115, 125, 135, 145 in the first exemplary embodiment) and are displayed in display segments 41, 42, 43, and 44, which are spatially assigned to station buttons 31, 32, 33, 34.

In accordance with the present invention as shown in FIG. 2, the radio receiver includes at least reference memories 51, 52, 53, 54 of a first reference memory level for a first station button assignment. According to FIG. 2, additional reference memories 55, 56, 57, and 58 of a second reference memory level are present for a second station button assignment, and additional reference memories 59, 60, 61, and 62 of a third reference memory level are present for a third station button assignment. A station button assignment change button 350 analogous to the memory level change button in FIG. 1 is used to switch between first, second, and third station button assignments.

Reference memories 51 through 54, 55 through 58, and 59 through 62 include references to a maximum of twelve program memories 11 through 26, as shown in the example in FIG. 2. The remaining four program memory spaces remain unassigned. This results from the consideration that a minimum number of program memories should be reserved for every broadcast method, in the present case eight for DAB, four for VHF FM, and four for MW AM.

According to the present invention, a station button level is decoupled from a broadcast method in the exemplary embodiment according to FIG. 2, i.e., references to program memories of different program memory levels may be stored in the reference memories of a given reference memory level or given station button level, e.g., reference memories 11 through 14 of the first station button level.

For example, as shown in FIG. 2, a reference to first program memory 11 of the first program memory level, i.e., to a DAB radio program, is stored in first reference memory 51 of the first level to which first station button 31 may be assigned. In contrast, a reference to second program memory 20 of the third program memory level, i.e., a VHF FM radio program, is stored in second reference memory 52 of the same first station button level, which is assignable to second station button 32. In this manner, changing between different program memory levels is achievable without operating the station button assignment change button 350, e.g., by simply operating second station button 32. Furthermore, a reference to fourth program memory space 14 of the first memory level, i.e., a DAB program, is stored in third reference memory 53 of the first level to which third station button 33 may be assigned. Finally, a reference to third program memory space 25 of the fourth memory level, i.e., a MW AM program, is stored in fourth reference memory 54 of the first reference memory or station button level to which fourth station button 34 may be assigned.

Upon operation of a station button, e.g., third station button 33, controller 30 accesses the reference memory assigned to this station button as reference memory 53, and, in the example shown in FIG. 2, the first reference memory level with reference memories 51 through 54 would be active. The reference information stored there includes a reference to fourth program memory 14 of the first program memory level. Consequently, controller 30 reads the tuning information, in this case SID4, from the referenced program memory. Moreover, controller 30 deduces from assignment table 37 that the program memories of the first memory level are DAB program memories. Therefore, controller 30 interprets the data read out from referenced program memory 14 as the SID of a DAB program, sets the DAB reception band at the receiving part (not shown), and initiates a search run there for a DAB program having the read out SID4. As a result, controller 30 tunes receiver 1 to the radio program stored under third station button 33 in the first (virtual) station button level and including SID4.

A program set in a conventional manner by the user per search run or by manual tuning is stored in a conventional manner by selecting a station button level, if necessary, by operating the station button assignment button 350 or station button level change button 35 and by subsequently operating and pressing and holding station button 31 through 34 under which the program is to be stored.

As an example, a scenario in which a new DAB program (SID7) is to be stored under first station button 31 in the second memory level, for example, is considered below, with various different initial situations.

a) First Example:

A reference to a stored program is already stored in first reference memory 55 of the second level to which the first station button for the second station button level is assigned, i.e., station button 31 is already assigned in the second station button level. The program that is saved and is to be overwritten is, for example, the fifth DAB program (SID5), i.e., reference memory 55 references first program memory 15 of the second program memory level.

In this situation, the contents of first program memory 15 of the second level are simply overwritten by the data of the currently received seventh DAB program (SID7). The reference to current program memory 15 is maintained in reference memory 55.

b) Second Example:

A reference to a stored program is already stored in first reference memory 55 of the second level to which the first station button 31 for the second station button level is assigned, i.e., station button 31 is already assigned in the second station button level. In contrast to case a) described above, the program that is stored and is to be overwritten is not a DAB program but, for example, a VHF FM program, e.g. the first VHF FM program in first program memory 19 of the third program memory level.

In this situation, the contents of program memory 19, which is currently assigned to the station button, may not simply be overwritten since the program memory is a VHF FM program memory and not a DAB program memory. The controller consequently determines the next free DAB program memory, i.e., the next available DAB program memory, to which reference memories 51 through 62 do not refer. In the situation shown in FIG. 2, this is third program memory 17 of the second program memory level. The controller enters a reference to third program memory 17 of the second program memory level instead of the reference to first program memory 19 of the third level into active reference memory 55 and writes the data of the currently received DAB program, i.e., its SID7, into thus referenced program memory 17.

However, if controller 30 does not include any available DAB memory space in the present example, i.e., if reference is already made to all DAB memory spaces, the storing process is discontinued with a corresponding error message to the user. Alternative possibilities for error handling, e.g., an offer to overwrite the DAB program set least frequently, may also be provided.

c) Third Example:

No reference is stored in first reference memory 55 of the second level to which first station button 31 for the second station button level is assigned, i.e., station button 31 is not yet assigned in the second station button level.

In this situation, the controller determines the next free DAB program memory, i.e., the next available DAB program memory, to which reference memories 51 through 62 do not refer. In the situation shown in FIG. 2, this is third program memory 17 of the second program memory level. The controller enters a reference to third program memory 17 of the second program memory level into active reference memory 55 and writes the data of the currently received DAB program, i.e., its SID7, into thus referenced program memory 17.

However, if controller 30 does not include any available DAB memory space in the present example, i.e., if reference is already made to all DAB memory spaces, the storing process is discontinued with a corresponding error message to the user.

Alternative possibilities for error handling, e.g., an offer to overwrite the DAB program set least frequently, may also be provided.

Thus far, the exemplary embodiments of the present invention involved separate program memories and a separate controller. However, it is within the scope of the present invention for the program memories to be realized as logical structures within one memory, e.g., a program memory of an automotive radio. Reference memories 51 through 62 of the second exemplary embodiment of the present invention, for example, may also be realized in the form of logical or technical program structures within one program memory. This also applies to assignment table 37, for example.

Moreover, instead of concrete station buttons 31 through 34, other operating elements that function in similar manner may also be provided.

Furthermore, the present invention is not limited to the radio standards indicated here, but rather may be easily used for receivers for other radio standards, such as digital satellite radio (DSR) or the like.

What is claimed is:

1. A radio receiver, comprising:
a plurality of selection elements for selecting a radio program; and
a plurality of program memories each storing information for setting a respective radio program, the program memories being assigned to corresponding selection elements;
wherein at least one program memory is accessed by operating a selection element assigned to the at least one program memory, independently of a broadcast method of a program received by the radio receiver prior to operation of the selection element assigned to the at least one program memory.

2. The radio receiver of claim 1, wherein the selection elements include at least two station buttons that are at least individually assignable, and wherein corresponding program memories assigned to the at least two station buttons are on a same assignment level selected from a plurality of assignment levels for assigning a station button.
